(19) United States
(12) Patent Application Publication
(10) Pub. No.: US 2012/0011477 A1
(43) Pub. Date: Jan. 12, 2012

(54) USER INTERFACES

(75) Inventor: Sunil Sivadas, Tampere (FI)

(73) Assignee: Nokia Corporation

(21) Appl. No.: 12/834,403

(22) Filed: Jul. 12, 2010

(51) Int. Cl. G06F 3/048; G06N 5/04

(52) U.S. Cl. 715/866; 706/55

(57) ABSTRACT

Apparatus comprises at least one processor; and at least one memory including computer program code. The memory and the computer program code are configured to, with the at least one processor, cause the apparatus at least to perform a method of: determining an emotional or physical condition of a user of a device; and changing either: a) a setting of a user interface of the device, or b) information presented through the user interface, dependent on the detected emotional or physical condition.

### FIELD OF THE INVENTION

This invention relates to user interfaces. Particularly, the invention relates to changing a user interface based on a condition of a user.

### BACKGROUND TO THE INVENTION

It is well known to provide portable communication devices, such as mobile telephones, with a user interface that causes graphics and text to be displayed on a display and that allows a user to provide inputs to the device, for the purpose of controlling the device and interacting with software applications.

### SUMMARY OF THE INVENTION

A first aspect of the invention provides a method comprising:

determining an emotional or physical condition of a user of a device; and

changing either:
a) a setting of a user interface of the device, or
b) information presented through the user interface,
   dependent on the detected emotional or physical condition.

Determining an emotional or physical condition of the user may comprises using semantic inference processing of text generated by the user. The semantic processing may be performed by a server that is configured to receive text generated by the user from a website, blog or social networking service.

Determining an emotional or physical condition of the user may comprises using physiological data obtained by one or more sensors.

Changing a setting of the user interface of the device or changing information presented through the user interface may be dependent also on information relating to a location of the user or relating to a level of activity of the user.

The method may comprise comparing a determined emotional or physical state of a user with an emotional or physical state of the user at an earlier time to determine a change in emotional or physical state, and changing the setting of the user interface or changing information presented through the user interface dependent on the change in emotional or physical state.

Changing a setting of a user interface may comprise changing information that is provided on a home screen of the device.

Changing a setting of a user interface may comprise changing one or more items that are provided on a home screen of the device.

Changing a setting of a user interface may comprise changing a theme or background setting of the device.

Changing information presented through the user interface may comprise automatically determining plural items of information that are appropriate to the detected emotional or physical condition, and displaying the items. This method may comprise determining a level of appropriateness for each of plural items of information and automatically displaying the ones of the plural items that are determined to have the highest levels of appropriateness. Here, determining a level of appropriateness for each of plural items of information may additionally comprise using contextual information.

A second aspect of the invention provides an apparatus comprising

at least one processor; and

at least one memory including computer program code,

the at least one memory and the computer program code configured to, with the at least one processor, cause the apparatus at least to perform a method of:

determining one of a) an emotional condition and b) a physical condition of a user of a device; and

changing one of:
a) a setting of a user interface of the device, and
b) information presented through the user interface,
   dependent on the detected condition of the user.

A third aspect of the invention provides apparatus comprising:

means for determining an emotional or physical condition of a user of a device; and

means for changing either:
a) a setting of a user interface of the device, or
b) information presented through the user interface,
   dependent on the detected emotional or physical condition.

### BRIEF DESCRIPTION OF THE DRAWINGS

Embodiments of the present invention will now be described, by way of example only, with reference to the accompanying drawings, in which:

FIG. 1 is a schematic diagram illustrating a mobile device according to aspects of the invention;

FIG. 2 is a schematic diagram illustrating a system according to aspects of the invention, the system including the mobile device of FIG. 1 and a server side; and

FIG. 3 is a flow chart illustrating operation of the FIG. 2 server according to aspects of the invention;

FIG. 4 is a flow chart illustrating operation of the FIG. 1 mobile device according to aspects of the invention; and

FIG. 5 is a screen shot provided by a user interface of the FIG. 1 mobile device according to some aspects of the invention.

### DETAILED DESCRIPTION OF EMBODIMENTS

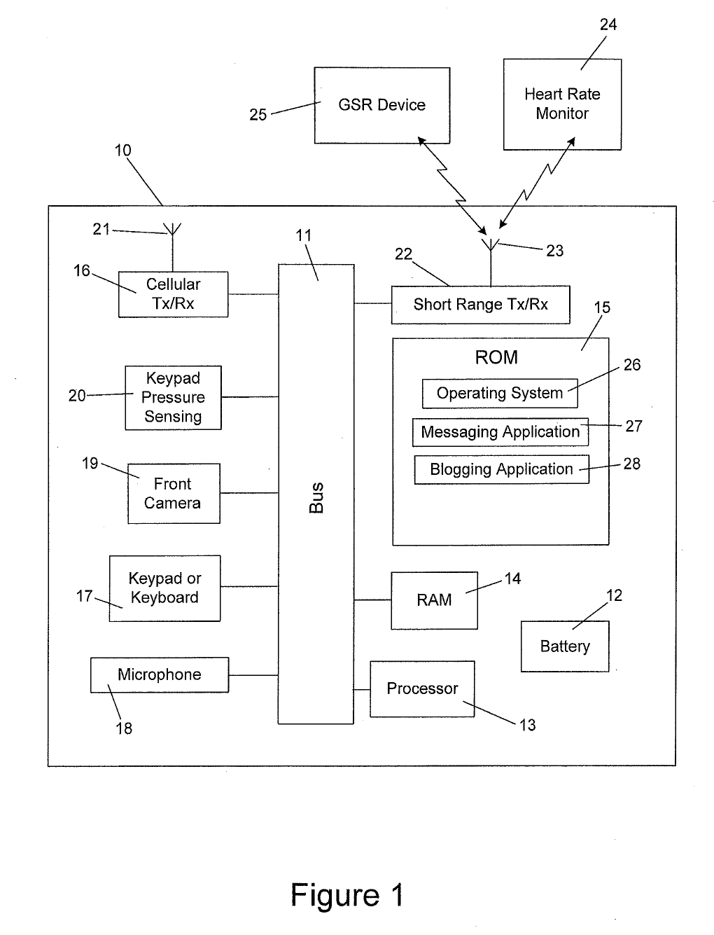

Referring firstly to FIG. 1, a mobile device 10 includes a number of components. Each component is commonly connected to a system bus 11, with the exception of a battery 12. Connected to the bus 11 are a processor 13, random access memory (RAM) 14, read only memory (ROM) 15, a cellular transmitter and receiver (transceiver) 16 and a keypad or keyboard 17. The cellular transceiver 16 is operable to communicate with a mobile telephone network by way of an antenna 21

The keypad or keyboard 17 may be of the type including hardware keys, or it may be a virtual keypad or keyboard, for instance implemented on a touch screen. The keypad or keyboard provides means by which a user can enter text into the device 10. Also connected to the bus 11 is a microphone 18. The microphone 18 provides another means by which a user can communicate text into the device 10.

The device 10 also includes a front camera 19. This camera is a relatively low resolution camera that is mounted on a front face of the device 10. The front camera 19 might be used for video calls, for instance.

The device 10 also includes a keypad or keyboard pressure sensing arrangement 20. This may take any suitable form. The function of the keypad or keyboard pressure sensing arrangement 20 is to detect a pressure that is applied by a user on the keypad or keyboard 17 when entering text. The form may depend on the type of the keypad or keyboard 17.

The device includes a short range transceiver 22, which is connected to a short range antenna 23. The transceiver may take any suitable form, for instance it may be a Bluetooth transceiver, an IRDA transceiver or any other standard or proprietary protocol transceiver. Using the short range transceiver 22, the mobile device 10 can communicate with an external heart rate monitor 24 and also with an external galvanic skin response (GSR) device 25.

Within the ROM 15 are stored a number of computer programs and software modules. These include an operating system 26, which may for instance be the MeeGo operating system or a version of the Symbian operating system. Also stored in the ROM 15 are one or more messaging applications 27. These may include an email application, an instant messaging application and/or any other type of messaging application that is capable of accommodating a mixture of text and image(s). Also stored in the ROM 15 are one or more blogging applications 28. This may include an application for providing microblogs, such as those currently used for instance in the Twitter service. The blogging application or applications 28 may also allow blogging to social networking services, such as Facebook™ and the like. The blogging applications 28 allow the user to provide status updates and other information in such a way that it is available to be viewed by their friends and family, or by the general public, for instance through the Internet. In the following description, one messaging application 27 and one blogging application are described for simplicity of explanation.

Although not shown in the Figure, the ROM 15 also includes various other software that together allow the device 10 to perform its required functions.

The device 10 may for instance be a mobile telephone or a smart phone. The device 10 may instead take a different form factor. For instance the device 10 may be a personal digital assistant (PDA), or netbook or similar. The device 10 in the main embodiments is a battery-powered handheld communications device.

The heart rate monitor 24 is configured to be supported by the user at a location such that it can detect the user's heartbeats. The GSR device 25 is worn by the user at a location where it is in contact with the user's skin, and as such is able to measure parameters such as resistance.

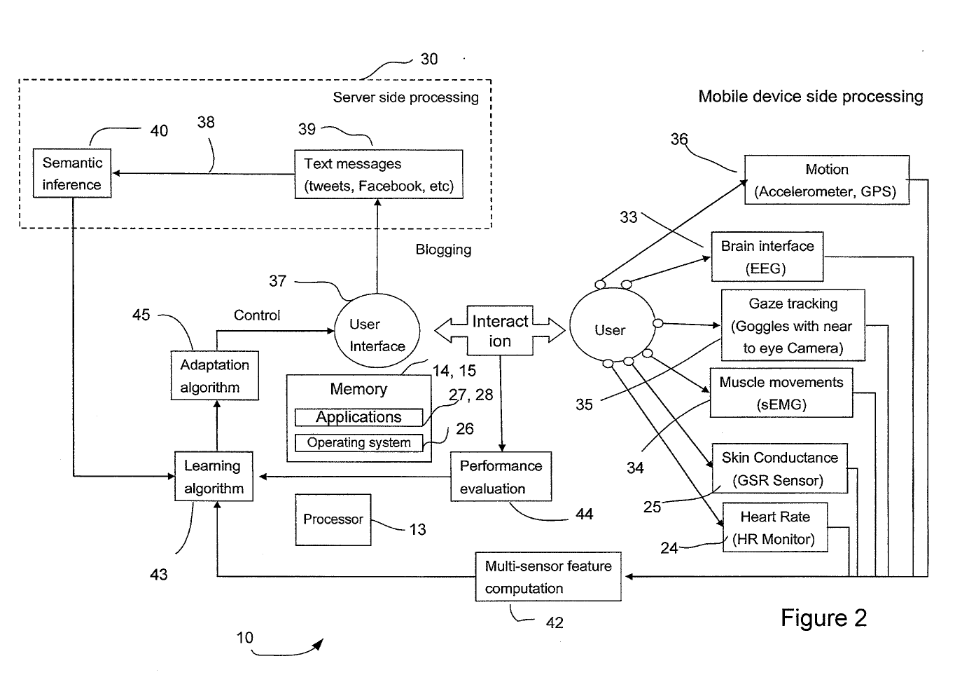

Referring now to FIG. 2, the mobile device 10 is shown connected to a server 30. Forming part of the device 10 and associated with a user 32 are a number of sensors. These include the heart rate monitor 24 and the GSR sensor 25. They also include a brain interface sensor (EEG) 33 and a muscle movement sensor (sEMG) 34. Also provided is a gaze tracking sensor 35, which may form part of goggles or spectacles. Further provided is a motion sensor arrangement 36. This may include one or more accelerometers, that are operable to detect acceleration of the device, unless detect whether the user is moving or is stationary. The motion sensor arrangement 36 may alternatively or in addition include a positioning receiver, such as a GPS receiver. It will be appreciated that a number of the sensors mentioned here involve components that are external to the mobile device 10. In FIG. 2, they are shown as part of the device 10 since they are connected to the device 10 in some way, typically through a wired link or wirelessly using a short range communication protocol.

The device 10 is shown as comprising a user interface 37. This incorporates the keypad or keyboard 17, but also includes outputs, particularly in the form of information and graphics provided on a display of the device 10. The user interface is implemented as a computer program, or software, that is configured to operate along with user interface hardware, including the keypad 17 and a display. The user interface software may be separate from the operating system 26, in which case it interacts closely with the operating system 26 as well as the applications. Alternatively, the user interface software may be integrated with the operating system 26.

The user interface 37 includes a home screen, which is an interactive image that is provided on the display of the device 10 at times when no active applications are provided on the display. The home screen is configurable by a user. The home screen may be provided with a time and date component, a weather component and a calendar component. The home screen may also be provided with shortcuts to one or more software applications. The shortcuts may or may not include active data relating to those applications. For instance, in the case of the weather application, the shortcut may be provided in the form of an icon that displays a graphic indicative of the weather forecast for the current location of the device 10. The home screen may additionally comprise shortcuts to web pages, in the form of bookmarks. The home screen may additionally comprise one or more shortcuts to contacts. For instance, the home screen may comprise an icon indicating a photograph of a family member of the user 32, whereby selecting the icon results in that family member's telephone number being dialed, or alternatively a contact for that family member being opened. As will be described below, the home screen of the user interface 37 is modified by the device depending on an emotional condition of the user 32.

Through the user interface 37, the user 32 is able to upload blogs, microblogs and status updates etc. using the blogging application 18 to on-line services such as Twitter™, Facebook™ etc. These messages and blogs etc. then reside at locations on the Internet. The server 30 includes a connection 38 by which it can receive such status updates, blogs etc. from an input interface 39. The content of these blogs, status updates etc. are received at a semantic inference engine 40, the operation of which is described in more detail below.

Inputs from the sensors 24, 25 and 32 to 36 are received at a multi-sensor feature computation module 42, which forms part of the mobile device 10.

Outputs from the multi-sensor feature computation module 42 and the semantic inference engine 40 are received at a learning algorithm module 43 of the mobile device. Also received at the learning algorithm module 43 are signals from a performance evaluation module 44, which forms part of the mobile device 10. The performance evaluation module 44 is configured to assess performance of interaction between the user 32 and the user interface 37 of the device 10.

An output of the learning algorithm module 43 is connected to an adaption algorithm module 45. The adaption algorithm module 45 exerts some control over the user interface 37. In particular, the adaption algorithm module 45 alters the interactive image, for instance the home page, provided by the user interface 37 depending on outputs of the learning algorithm module 43. This is described in more detail below.

The mobile device 10 and the server 30 together monitor a physical or emotional condition of the user 32 and adapt the user interface 37 with the aim of being more useful to the user in their physical or emotional condition.

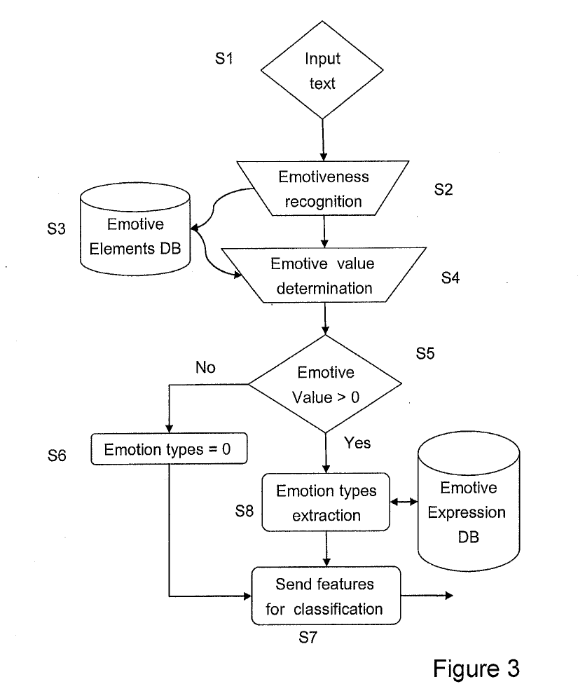

FIG. 3 is a flow diagram that illustrates operation of the server 30, in particular operation of the semantic inference engine 40. Operation starts at step S1 with the receipt of input text from the module 39. Step S2 performs emotiveness recognition on the input text. Step S2 involves an emotive elements database S3. An emotive value determination is made at step S4 using inputs from the emotiveness recognition step S2 and the emotive elements database S3. The emotive elements database S3 includes a dictionary, a thesaurus and domain specific key phrases. It also includes attributes. All of these elements can be used by the emotive value determination step S4 to attribute a value to any emotion that is implied in the input text received at step S1. The emotiveness recognition step S2 and the emotive value determination step S4 involve feature extraction, in particular domain specific key-phrase extraction, parsing and attribute tagging. The features extracted from text will typically be a two dimensional vector [arousal valence]. For instance, arousal values may be in a range (0.0, 1.0) and valence may be in a range (−1.0, 1.0)

An example input of text is “Are you coming to dinner tonight?”. This phrase is processed by the semantic inference engine 40 by breaking it down into its individual components. The word “you” is known from the emotive elements database S3 to be an auxiliary pronoun, that is denotes a second person and thus is directed. The word “coming” is known by the emotive elements database S3 to be a verb gerund. The phrase “dinner tonight” is identified as being a key phrase, that might be a social event. From the “?” the semantic inference engine 40 knows that action is expected, because the character is an interrogative. From the word “tonight”, the semantic inference engine 40 knows that the word is identified as a temporal adverb that identifies an event in the future. In conjunction with the words “you” and “coming”, the semantic inference engine 40 is able to determine that the text relates to an action in the future. With this example, the semantic inference engine 40 at step S4 determines that there is no emotive content in the text, and allocates an emotive value of zero. A comparison of the emotive value at step S5 with the value of zero leads to a step S6 on a negative determination. Here, a parameter at “emotion type” is set to zero, and this information is sent for classification at step S7. Following a positive determination from step S5 (from a different text string), the operation proceeds to step S8. Here, the type or types of emotion that are inferred by the text message are extracted. This step involves use of an emotive expression database. An output of step S8 is sent for classification at step S7. Step S7 involves sending features provided by either of steps S6 and S8 to the learning algorithm module 43 of the mobile device 10. The emotion features sent for classification at step S7 indicate the presence of no emotion for text such as “are you coming for dinner tonight?”, “I am reading Lost Symbol” and “I am running late”. However, for the text “I am in a pub!!”, the semantic inference engine 40 determines, particularly from the noun “pub” and the choice of punctuation, that the user 32 is in a happy state. The skilled person will appreciate that other emotion conditions that can be inferred from text strings that are blogged or provided as status information by the user 32.

Although not shown in FIG. 3, the semantic inference engine 40 is configured also to infer a physical condition of the user from the input text at step S1. From the text “I am reading Lost Symbol”, the semantic inference engine 40 is able to determine that the user 32 is performing a non-physical activity, in particular reading. From the text “I am running late”, the semantic inference engine 40 is able to determine that the user 32 is not physically running, and is able to determine that the verb gerund “running” instead is modified by the word “late”. From the text “I am in a pub!!”, the semantic inference engine 40 is able to determine that the text indicates a physical location of the user, not a physical condition.

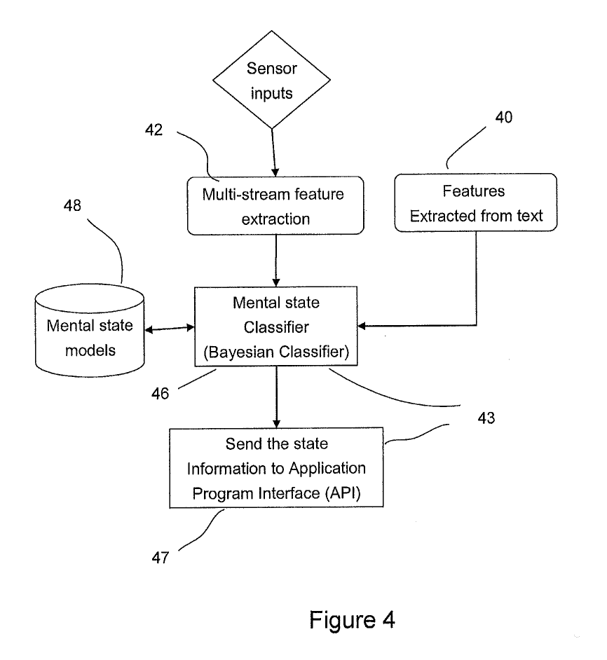

Referring now to FIG. 4, sensor inputs are received at the multi-sensor feature computation component 42. Physical and emotional conditions extracted from the text by the semantics inference engine 40 are provided to the learning algorithm module 43 along with information from the sensors. As shown at FIG. 4, the learning algorithm module 43 includes a mental state classifier, for instance a Bayesian classifier, 46, and an output 47 to an application programming interface (API). The mental state classifier 46 is connected to a mental state models database 48.

The mental state classifier 46 is configured to classify an emotional condition of the user, utilising inputs from the multi-sensor feature computation component 42 and the semantic inference engine 40. The classifier preferably is derived as a result of training using data collected from real users over a period of time in simulated situations soliciting emotions. In this way, the classification of the emotion condition of the user 32 can be made to be more accurate than might otherwise be possible.

The results of the classification are sent to the adaptation algorithm module 45 by way of the output 47.

The adaptation algorithm module 45 is configured to alter one or more settings of the user interface 37 depending on the emotional condition provided by the classifier 46. A number of examples will now be described.

In a first example, a user has posted the text “I am reading Lost Symbol” to a blog, for instance Twitter™ or Facebook™. This is understood by the semantic engine 40, and provided to the learning algorithm module 43. The adaptation algorithm module 45 is provided with an emotional condition classification of the user 32 by the learning algorithm module 43. The adaptation algorithm module 45 is configured to confirm that the user is indeed partaking in a reading activity utilising outputs of the emotion sensors 36. This can be confirmed by determining that motion, as detected by an accelerometer sensor for instance, is at a low level, consistent with a user reading a book. The emotional response of the user 32 as they read the book results in changes in output of various sensors, including the heart rate monitor 24, the GSR sensor 25 and the EEG sensor 33. The adaptation algorithm module 45 adjusts a setting of the user interface 37 to reflect the emotion conditional of the user 32. In one example, a colour setting of the user interface 37 is adjusted depending on the detected emotional condition. In particular, the dominant background colour of the home page may change from one colour, for instance green, to a colour associated with the emotional condition, for instance red for a state of excitation. If the blog message is provided on the home page of the user interface 37, or if a shortcut to the blogging application 28 is provided on the home page, the colour of the shortcut or the text itself may be adjusted by the adaptation algorithm module 45. Alternatively or in addition, a setting relating to a physical aspect of the user interface 37, for instance a dominant colour of the background or an appearance of the relevant shortcut, may be modulated to change along with the heart rate of the user 32, as detected by the heart rate monitor 24.

In the case of a user posting a blog or status update “I am running late”, the mobile device 10 may detect from a positioning receiver, such as the GPS receiver included in the motion sensing transducer arrangement 36, that the user is at their home location, or alternatively their office location. Furthermore, from the motion transducer, for instance the accelerometer, the mobile device 10 can determine that the user 32 is not physically running, nor travelling in a vehicle or otherwise. This constitutes a determination of a physical condition of the user. In response to such a determination, and considering the text, the application algorithm module 45 controls the user interface 37 to change a setting of the user interface 37 to give a calendar application a more prominent position on the home screen. Alternatively or in addition, the adaptation algorithm module 45 controls a setting of the user interface 37 to provide on the home screen a timetable of public transport from the current location of the user, and/or a report of traffic conditions on main routes near to the current location of the user.

In a situation where the user has provided the text “I am in a pub!!”, the adaptation algorithm module 45 monitors both the physical condition and the emotional condition of the user using outputs of the multi-sensor feature computation component 42. If the adaptation algorithm module 45 detects that after a predetermined period of time, for instance an hour, the user is not in an excited emotional condition and/or is relatively inactive, the adaptation algorithm module 45 controls a setting of the user interface 37 such as to provide on the home screen or in the form of a message a recommendation in the user interface 37 for an alternative leisure activity. The alternative may be an alternative pub, or a film that is showing at a cinema local to the user, or alternatively the locations and potentially other information about some friends or family members of the user 32 whom have been determined to be nearby the user.

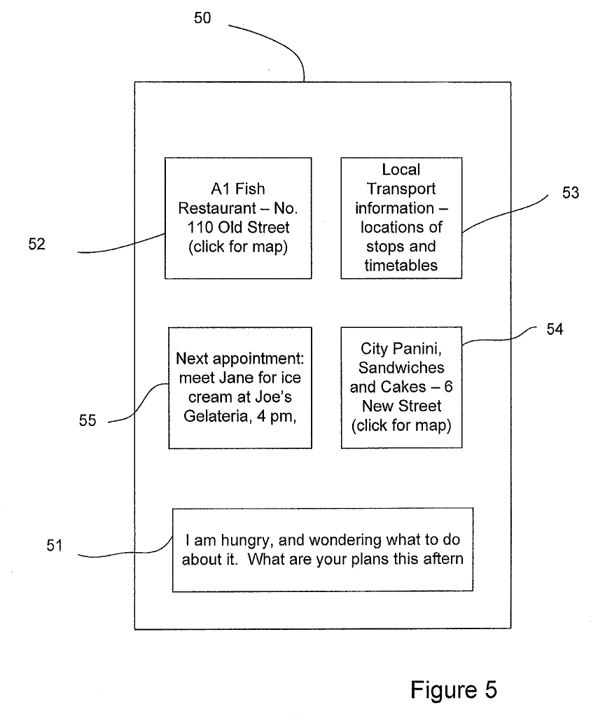

In another embodiment, the device 10 is configured to control the user interface 37 to provide to the user plural possible actions based on the emotional or physical condition of the user, and to change the possible actions presented through the user interface based on text entered by the user or actions selected by the user. An example will now be described with reference to FIG. 5.

FIG. 5 is a screenshot of a display provided by the user interface 37 when the device 10 is executing the messaging application 27. The screenshot 50 includes at a lowermost part of the display a text entry box 51. In the text entry box 51, the user is able to enter text that is to be sent to a remote party, for instance by SMS or by Instant Messaging. Above the text entry box 51 are first to fourth regions 52 to 55, each of which relates to a possible action that may be performed by the user.

For instance, after the user has opened or executed the messaging application 17 but before the user commences typing text into the text entry box 51, the user interface 37 of the device is controlled to provide first to fourth possible actions in the regions 52 to 55 of the display 50. The possible actions are selected by the learning algorithm 43 on the basis of the mental or physical condition of the user and from context information detected by the sensors 24, 25, 33 to 36 and/or from other sources such as a clock application and calendar data. Alternatively, the user interface 37 may display possible actions that are set by a manufacturer or service provider or by the user of the device 10. For instance, the possible actions presented prior to the user beginning to enter text into the text entry box 51 may be the next calendar appointment, which is shown in FIG. 5 at the region 55, a shortcut to a map application, a shortcut to contact details of the spouse of the user of the device 10 and a shortcut to a website, for instance the user's homepage.

Subsequently, the user commences entering text into the text entry box 51. In FIG. 5, some example text is shown. In this embodiment, the device 10 includes a copy of the semantic inference engine 40 that is shown to be at the server 30 in FIG. 2. The device 10 uses the semantic inference engine 40 to determine an emotional or physical condition of the user of the device 10. The learning algorithm 43 and the adaptation algorithm 45 are configured to use the information so determined to control the user interface 37 to present possible actions at the regions 52 to 55 that are more appropriate to the user's current situation. For instance, based on the text shown in the text entry box FIG. 1 or FIG. 5, the semantic inference engine 40 may determine that the user's emotional condition is hungry. Additionally, the semantic inference engine 40 may determine that the user is enquiring about a social meeting, and infer there from that the user is feeling sociable. The learning algorithm 43 and the adaptation algorithm 45 use this information to control the user interface 37 to provide possible actions that are appropriate to the emotional and physical conditions of the user of the device 10. In FIG. 5, it is shown that the user interface 37 has provided details of two local restaurants, at regions 52 and 54 respectively. The user interface 37 also has provided at region 55 the next calendar appointment. This is provided on the basis that it is determined by the learning algorithm 43 and the adaptation algorithm 45 that it may be useful to the user to know their commitments prior to making social arrangements. The user interface 37 also has provided at region 53 a possible action of access to information about local public transport. This is provided on the basis that the device 10 has determined that the information might be useful to the user if they need to travel to make a social appointment.

The possible actions selected for display by the user interface 37 are selected by the learning algorithm 43 and 45 on the basis of a point scoring system. Points are awarded to a possible action based on some or all of the following factors: a user's history, for instance of visiting restaurants, the user's location, the user's emotional state, as determined by the inference engine 40, the user's physical state, as determined by the semantic inference engine 40 and/or the sensors 24, 25 and 33 to 36, and the user's current preferences, as may be determined for instance by detecting which possible actions are selected by the user for information and/or investigation. The number of points associated with a possible action are adjusted continuously, so as to reflect accurately the current condition of the user. The user interface 37 is configured to display a predetermined number of possible actions that have the highest score at any given time. In FIG. 5, the predetermined number of possible actions is four, so the user interface 37 shows the four possible actions that have the highest score at any given time in respective ones of the regions 52 to 55. It is because of this that the possible actions that are displayed by the user interface 37 changes over time, and because text entered by the user into the text entry box 51 can change the possible actions that are presented for display.

It will be appreciated that this embodiment involves the semantic inference engine 40 being located in the mobile device 10. The semantic inference engine 40 may also be located at the server 30. In this case, the content of the semantic inference engine 40 may be synchronised with or copied to the semantic inference engine located within the mobile device 10. Synchronisation may occur on any suitable basis and in any suitable way.

In a further embodiment, the device 10 is configured to control the user interface 37 to provide possible actions for display based on the emotional condition and/or the physical condition of the user as well as context. The context may include one or more of the following: the user's physical location, weather conditions, the length of time that the user has been at their current location, the time of day, the day of the week, the user's next commitment (and optionally the location of the commitment), and information concerning where a user has been located previously, with particular emphasis given to recent locations.

In one example, the device determines that the user is located at Trafalgar Square in London, that it is midday, that the user has been at the location for 8 minutes, that the day of the week is Sunday, and that the prevailing weather conditions are rain. The device determines also from the user's calendar that the user has a theatre commitment at 7:30 pm that day. The learning algorithm 43 is configured to detect from information provided by the sensors 24, 25 and 33 to 36 and/or from text generated by the user in association with the messaging application 27 and/or the blogging application 28 a physical condition and/or an emotional condition of the user. Using this information in conjunction with the context information, the learning algorithm 43 and the adaptation algorithm 45 select a number of possible actions that have the highest likelihood of being relevant to the user. For instance, the user interface 37 may be controlled to provide possible actions including details of a local museum, details of a local lunch venue and a shortcut to an online music store, for instance the Ovi (™) store provided by Nokia Corporation. As with the previous embodiment, the possible actions that are selected for display by the user interface 37 are allocated points using a point scoring system and the possible actions with the highest numbers of points are selected for display at a given time.

The adaptation algorithm module 45 may be configured or programmed to learn how the user responds to events and situations, and adjusts recommendations provided on the home screen accordingly.

For example, content and applications in the device 10 may be provided with metadata fields. Values included in these fields may be allocated (for instance by the learning algorithm 43) denoting the physical and emotional state of the user before and after an application is used, or content consumed, in the device 10. For instance, in respect of a comedy TV show content item, a movie, an audio content item such as a music track or album, or a comedy platform game application, metadata fields may be completed as follows:

| [Mood_Before | Mood_After | Activity] |
|---|---|---|
| 0.1 Happy | 0.7 Happy | 0.8 Rest |
| 0.8 Sad | 0.2 Sad | 0.1 Run |
| 0.1 Angry | 0.1 Angry | 0.1 Car |

The metadata indicates the probability of the condition being the actual condition of the user, according to the mental state classifier 46. This data shows how the content item or game transformed the user's emotional condition prior to consuming the content or playing the game to their emotional condition afterwards. It also shows the user's physical state whilst completing the activity.

Instead of an application or a content item, the data may relates to an event such as posting a micro-blog message in IM, Facebook™, Twitter™ etc.

Using the current physical & mental context information and the set of target tasks, the reinforcement learning algorithm 43 and the adaptation algorithm 45 can formulate the actions that results in best rewards to the user.

It will be appreciated that steps and operations described above are performed by the processor 13, using the RAM 14, under control of instructions that form part of the user interface 37, or the blogging application 28, running on the operating system 26. During execution, some or all of the computer program that constitutes the operating system 26, the blogging application 28 and the user interface 37 may be stored in the RAM 14. In the event that only some of this computer program is stored in the RAM 14, the remainder resides in the ROM 15.

Using features of the embodiments, the user 32 can be provided with information through the user interface 37 of the mobile device 10 that is more relevant to their situation than is possible with prior art devices.

It should be realized that the foregoing embodiments should not be construed as limiting. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. A method comprising:
determining an emotional or physical condition of a user of a device; and
changing either:
a) a setting of a user interface of the device, or
b) information presented through the user interface,
dependent on the detected emotional or physical condition.

2. A method as claimed in claim 1, wherein determining an emotional or physical condition of the user comprises using semantic inference processing of text generated by the user.

3. A method as claimed in claim 2, wherein the semantic processing is performed by a server that is configured to receive text generated by the user from a website, blog or social networking service.

4. A method as claimed in claim 1, wherein determining an emotional or physical condition of the user comprises using physiological data obtained by one or more sensors.

5. A method as claimed in claim 1, wherein changing a setting of the user interface of the device or changing information presented through the user interface is dependent also on information relating to a location of the user or relating to a level of activity of the user.

6. A method as claimed in claim 1, comprising comparing a determined emotional or physical state of a user with an emotional or physical state of the user at an earlier time to determine a change in emotional or physical state, and changing the setting of the user interface or changing information presented through the user interface dependent on the change in emotional or physical state.

7. A method as claimed in claim 1, wherein changing a setting of a user interface comprises changing information that is provided on a home screen of the device.

8. A method as claimed in claim 1, wherein changing a setting of a user interface comprises changing one or more items that are provided on a home screen of the device.

9. A method as claimed in claim 1, wherein changing a setting of a user interface comprises changing a theme or background setting of the device.

10. A method as claimed in claim 1, wherein changing information presented through the user interface comprises automatically determining plural items of information that are appropriate to the detected emotional or physical condition, and displaying the items.

11. A method as claimed in claim 10, comprising determining a level of appropriateness for each of plural items of information and automatically displaying the ones of the plural items that are determined to have the highest levels of appropriateness.

12. A method as claimed in claim 11, wherein determining a level of appropriateness for each of plural items of information additionally comprises using contextual information.

13. An apparatus comprising
at least one processor; and
at least one memory including computer program code,
the at least one memory and the computer program code configured to, with the at least one processor, cause the apparatus at least to perform a method of:
determining one of a) an emotional condition and b) a physical condition of a user of a device; and
changing one of:
a) a setting of a user interface of the device, and
b) information presented through the user interface,
dependent on the detected condition of the user.

14. Apparatus as claimed in claim 13, wherein the at least one memory and the computer program code are configured to, with the at least one processor, cause the apparatus additionally to perform a method of: determining one of a) an emotional condition and b) a physical condition of the user comprises using semantic inference processing of text generated by the user.

15. Apparatus as claimed in claim 14, wherein the semantic processing is performed by at least one processor in a server that is configured to receive text generated by the user from one of: a) a website, b) a blog, and c) a social networking service.

16. Apparatus as claimed in claim 13, wherein the at least one memory and the computer program code are configured to, with the at least one processor, cause the apparatus additionally to perform a method of: using physiological data obtained by at least one sensor to determine the condition of the user.

17. (canceled)

18. Apparatus as claimed in claim 13, wherein the at least one memory and the computer program code are configured to, with the at least one processor, cause the apparatus additionally to perform a method of:
comparing a determined state of a user with an state of the user at an earlier time to determine a change in state of the user, and
one of a) changing the setting of the user interface and b) changing information presented through the user interface dependent on the change in state of the user.

19. Apparatus as claimed in claim 18, wherein the at least one memory and the computer program code are configured to, with the at least one processor, cause the apparatus additionally to perform a method of: changing information presented through the user interface by automatically determining plural items of information that are appropriate to the detected condition of the user, and displaying the items.

20. Apparatus as claimed in claim 19, wherein the at least one memory and the computer program code are configured to, with the at least one processor, cause the apparatus additionally to perform a method of: determining a level of appropriateness for each of plural items of information and automatically displaying the ones of the plural items that are determined to have the highest levels of appropriateness.

21-33. (canceled)

34. A computer readable medium having stored thereon computer code for performing a method comprising:
determining an emotional or physical condition of a user of a device; and
changing one of:
a) a setting of a user interface of the device, and
b) information presented through the user interface,
dependent on the detected emotional or physical condition.
